(19) United States
(12) Patent Application Publication
(10) Pub. No.: US 2026/0159068 A1
(43) Pub. Date: Jun. 11, 2026

(54) METHOD FOR CONTROLLING A HYBRID VEHICLE AND A RECORDING MEDIUM THEREOF

(71) Applicants: HYUNDAI MOTOR COMPANY, Seoul (KR); KIA CORPORATION, Seoul (KR)

(72) Inventor: Jinyoung Hwang, Hwaseong-si (KR)

(73) Assignees: HYUNDAI MOTOR COMPANY, Seoul (KR); KIA CORPORATION, Seoul (KR)

(21) Appl. No.: 19/384,762

(22) Filed: Nov. 10, 2025

(30) Foreign Application Priority Data
Dec. 6, 2024 (KR) 10-2024-0181003

(51) Int. Cl. B60W 20/50; B60K 6/26; B60K 6/52; B60W 10/02; B60W 10/06; B60W 10/08; B60W 20/13; B60W 50/038

(52) U.S. Cl. CPC B60W 20/50; B60K 6/26; B60K 6/52; B60W 10/02; B60W 10/06; B60W 10/08; B60W 20/13; B60W 50/038; B60W 2510/0638; B60W 2510/0666; B60W 2510/244; B60W 2520/10; B60W 2710/021; B60W 2710/06; B60W 2710/08; B60W 2710/244; B60W 2720/10; B60Y 2200/92; B60Y 2300/425; B60Y 2300/43; B60Y 2300/60; B60Y 2300/91; B60Y 2306/13; B60Y 2400/82

(57) ABSTRACT

A method for controlling a limp-home mode of a hybrid vehicle that uses an engine to charge a high-voltage battery includes: initiating a limp home mode when a failure in a second motor is detected while the vehicle is running; determining whether the vehicle speed detected when the vehicle is driving in the limp home mode exceeds a lower limit vehicle speed predetermined based on a condition for maintaining an engine start; controlling the vehicle in an electric vehicle (EV) mode in which the vehicle is driven using only a first motor when the vehicle speed is lower than the lower limit vehicle speed; and controlling the vehicle in a hybrid electric vehicle (HEV) mode in which the vehicle is driven by the engine and the first motor when the vehicle speed exceeds the lower limit vehicle speed.

### CROSS-REFERENCE TO RELATED APPLICATION

This application claims priority to and the benefit of Korean Patent Application No. 10-2024-0181003, filed on Dec. 6, 2024, the entire contents of which are incorporated herein by reference.

### FIELD

The present disclosure relates to a method for controlling a hybrid vehicle and a recording medium thereof.

### BACKGROUND

In general, improving a fuel efficiency of vehicles is a key technology that will determine a survival of a future automobile industry. Accordingly, major automobile manufacturers are devoting significant effort to researching and improving the fuel efficiency of their vehicles to meet the demands of the times, such as environmental and fuel efficiency regulations.

Recently, the automobile industry is undergoing a technological transition from conventional internal combustion engine vehicles to electric vehicles. For example, as the market share of hybrid electric vehicles (HEVs) and plug-in HEVs (PHEVs) increases, electrification technologies are also gradually becoming more advanced.

For example, PHEV systems mainly use power trains (PT) with structures such as a toyota hybrid system (THS) or a transmission mounted electric device (TMED), which use the power of the engine and motor as an output. Recently, as the market share of the PHEV systems has increased, the number of extended range electric vehicles (EREVs), which use a motor for driving and utilize an engine only for charging to extend the driving range, has been steadily increasing.

These EREV vehicles are powered only by a motor, so they have the advantage of being able to utilize the same control system as electric vehicles (EVs). Since the engine is not used for the propulsion, it can operate only at its optimal efficiency point. Also, since a friction losses may be reduced by applying a small engine, there is an additional advantage of improved fuel efficiency.

On the other hand, EREV vehicles do not use the engine for the power output, so they are vulnerable to a limp home mode when the motor fails, rendering the vehicle inoperable.

The above information disclosed in this Background section is only for enhancement of understanding of the background of the present disclosure and therefore it may contain information that does not form the prior art that is already known to a person of ordinary skill in the art.

### SUMMARY

Embodiments of the present disclosure provide a control method of a hybrid vehicle and a recording medium therefore, which support a stable limp-home mode by utilizing an engine output as a driving force to maintain the safe driving in the event of the motor failure of the EREV system that uses the engine for charging a high-voltage battery.

According to an embodiment, a method is provided for controlling a hybrid vehicle in a limp home mode, the hybrid vehicle including a first motor configured to provide a driving force to one of front or rear wheels, and a second motor configured to provide a driving force to the other of the front or rear wheels. The method includes: initiating, by a controller, the limp home mode when a failure in the second motor is detected while the vehicle is operating; determining, by the controller, whether a vehicle speed detected when the vehicle is driving in the limp home mode is equal to or less than a lower limit vehicle speed predetermined based on a condition for maintaining an engine start; controlling, by the controller, the vehicle in an electric vehicle (EV) mode in which the vehicle is driven using only the first motor when the vehicle speed is lower than or equal to the lower limit vehicle speed; and controlling, by the controller, the vehicle in a hybrid electric vehicle (HEV) mode in which the vehicle is driven by the engine and the first motor when the vehicle speed exceeds the lower limit vehicle speed (A kph).

Controlling the vehicle in the EV mode may include disengaging a first clutch provided between the engine and the first motor, and engaging a second clutch provided between a first reducer and a first axle to control the vehicle speed and a torque of the first motor.

Controlling the vehicle in the HEV mode may include limiting the vehicle speed to an upper limit vehicle speed (B kph) predetermined in the limp home mode; and engaging a first clutch provided between the engine and the first motor, and a second clutch provided between a first reducer and a first axle to control the vehicle speed and torque of the first motor;

The upper speed limit may be set as a vehicle speed at a maximum engine rpm determined by a reduction ratio of the first reducer.

Controlling the vehicle in the HEV mode may include performing a load leveling based on the SOC of a high-voltage battery that is configured to supply a power to the second motor and the first motor or to be charged with the power generated by the second motor and the first motor; and determining an engine output and an operating point of the first motor.

Performing the load leveling may include setting a target SOC value (X SOC) based on a current SOC of the high-voltage battery for the limp home mode; and controlling the engine and the first motor so that the current SOC follows the target SOC value (X SOC).

Determining the engine output and the operating point of the first motor may include: controlling the engine output to be higher than a required output of the vehicle when the current SOC of the high-voltage battery is less than the target SOC value, and generating a power through the first motor to charge the high-voltage battery.

Determining the engine output and the operating point of the first motor may include: controlling the engine output to be lower than a vehicle required output when the current SOC of the high-voltage battery is greater than the target SOC value, and supplying a power of the high-voltage battery to the first motor to assist the engine output.

In another embodiment, a computer-determined recording medium storing a program including instructions for performing a limp home mode control method of an extended range electric vehicle (EREV) that uses an engine for charging a high-voltage battery is provided. The instructions, when executed by a computing device including one or more processors, cause the computing device to perform the method of controlling the vehicle including a first motor powering one of front or rear wheels, and a second motor powering the other of the front or rear wheels. The method comprises: initiating the limp home mode when detecting a failure in the second motor while the vehicle is operating; determining whether a vehicle speed detected in the limp home mode exceeds a lower limit vehicle speed (A kph) predetermined based on a condition for maintaining the engine start; controlling the vehicle in an electric vehicle (EV) mode in which the vehicle is driven using only the first motor based on determining that the vehicle speed does not exceed the lower limit vehicle speed (A kph); and controlling the vehicle in a hybrid electric vehicle (HEV) mode in which the vehicle is driven using both the engine and the first motor based on determining that the vehicle speed exceeds the lower limit vehicle speed (A kph).

In another embodiment, a hybrid vehicle comprises: a first motor configured to provide a driving force to one of front or rear wheels; a second motor configured to provide a driving force to the other of the front or rear wheels; and a controller configured to: initiate a limp-home mode upon determining that a failure in the second motor is detected while the hybrid vehicle is operating, determine whether a vehicle speed of the hybrid vehicle in the limp-home mode is less than or equal to a predetermined low-limit vehicle speed predetermined based on a condition for maintaining engine start, control the hybrid vehicle in an electric vehicle (EV) mode in which the hybrid vehicle is driven using only the first motor, when it is determined that the vehicle speed is less than or equal to the predetermined low-limit vehicle speed, and control the hybrid vehicle in a hybrid electric vehicle (HEV) mode in which the hybrid vehicle is driven using both the engine and the first motor, when it is determined that the vehicle speed exceeds the predetermined low-limit vehicle speed.

According to one embodiment, in the hybrid vehicle that uses the engine for the charging, the reliability of the vehicle product may be improved by providing the safe driving (Fil Safe) by utilizing the engine output for the limp home mode in the event of the motor failure.

In addition, since the conventional EREV system may be used as it is and the performance of the limp home mode may be improved by only changing the software without any additional hardware, it has the effect of improving a marketability without an additional cost.

### BRIEF DESCRIPTION OF THE DRAWINGS

FIG. 1 is a view showing a configuration and a driving state of a hybrid vehicle according to one embodiment.

FIG. 2 is a view illustrating a limp home mode control state when a motor of a hybrid vehicle fails according to one embodiment.

FIG. 3 is a flowchart schematically illustrating a limp home mode control method in an event of a motor failure of a hybrid vehicle according to one embodiment.

FIG. 4 is a view illustrating a driving control method of an engine and a P1 motor by comparing a speed and a torque map (MAP) according to one embodiment.

FIG. 5 shows an example of a battery SOC target value tracking load leveling control according to one embodiment.

FIG. 6 is a view for explaining a computing device according to one embodiment.

The drawings described herein are for illustration purposes only and are not intended to limit the scope of the present disclosure in any way.

### DETAILED DESCRIPTION

The present disclosure is described more fully hereinafter with reference to the accompanying drawings, in which certain embodiments of the present disclosure are illustrated.

The terminology used herein is for the purpose of describing particular embodiments only and is not intended to be limiting of the present disclosure. As used herein, the singular forms are intended to include the plural forms as well, unless the context clearly indicates otherwise. As used herein, the terms “comprises” and/or “comprising” refer to the presence of specified features, integers, steps, acts, elements and/or components, but it should also be understood that it does not exclude a presence or an addition of one or more other features, integers, steps, acts, components, and/or groups thereof. As used herein, the term “and/or” includes any one or all combinations of one or more related items.

Throughout the specification, terms such as first, second, “A”, “B”, “(a)”, “(b)”, and the like will be used only to describe various elements, and are not to be interpreted as limiting these elements. These terms are only for distinguishing the constituent elements from other constituent elements, and nature or order of the constituent elements is not limited by the terms.

In this specification, it is to be understood that when one component is referred to as being “connected” or “coupled” to another component, it may be connected or coupled directly to the other component or may be connected or coupled to the other component with a further component intervening therebetween. On the other hand, in this specification, it is to be understood that when one component is referred to as being “connected or coupled directly” to another component, it may be connected or coupled to the other component without another component intervening therebetween.

Terms used in the present specification are used only to describe specific exemplary embodiments, and are not intended to limit the present disclosure. Singular expressions used herein include plural expressions unless they have definitely opposite meanings in the context. When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, controller, device, element, apparatus, and the like may separately embody or be included with a processor and a memory, such as a non-transitory computer readable media, as part of the apparatus. The term “unit” or “module” used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof.

Additionally, it is understood that one or more of the methods or aspects thereof below may be executed by at least one controller. The term “controller” may refer to a hardware device that includes a memory and a processor. The memory is configured to store program instructions, and the processor is specifically programmed to execute the program instructions to perform one or more processes described in more detail below. The controller may control the operation of units, modules, components, devices, or the like, as described herein. Additionally, it is understood that the methods below may be implemented by a device including a controller together with one or more other components, as will be appreciated by those having ordinary skill in the art.

According to an embodiment, a limp-home mode control method of a hybrid vehicle and a recording medium therefor are described in detail with reference to attached drawings.

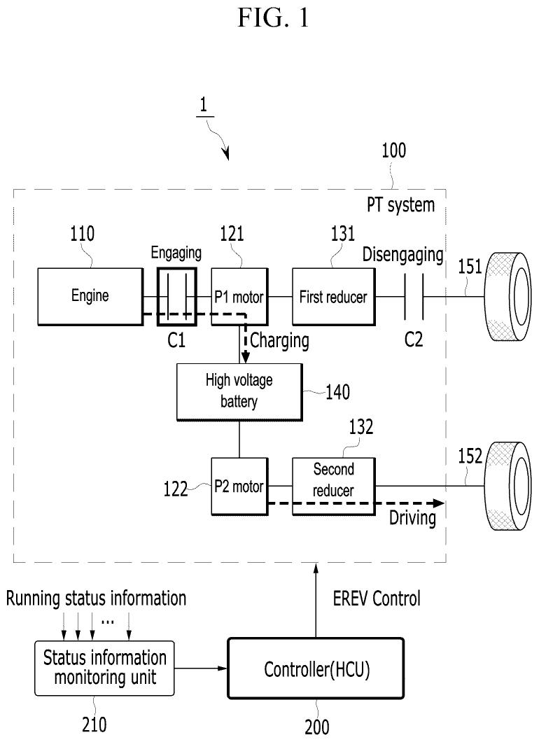

FIG. 1 is a view showing a configuration and a driving state of a hybrid vehicle according to one embodiment.

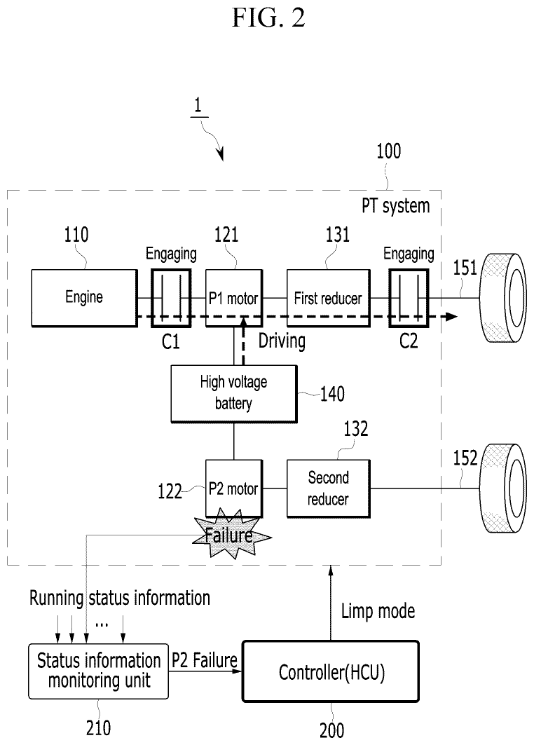

FIG. 2 is a view illustrating a limp home mode control state when a motor of a hybrid vehicle fails according to one embodiment.

Referring to FIG. 1 and FIG. 2, a hybrid vehicle 1 according to one embodiment includes a power train (PT) system 100 and a controller 200 that controls the same.

In the PT system 100, an engine 110, a first clutch C1, a P1 motor 121, a first reducer 131, and a second clutch C2 may be sequentially connected along a first axle 151, and a P2 motor 122 and a second reducer 132 may be connected along a second axle 152. Also, the PT system 100 may include a high-voltage battery 140 that is electrically connected to the P2 motor 122 and the P1 motor 121, and is configured to supply (discharge) driving power to the P2 motor 122 and the P1 motor 121, or to be charged with a power (a generated power) produced by the P2 motor 122 and the P1 motor 121.

The controller 200 controls the operation of the PT system 100, and when a failure event occurs in the P2 motor 122, it performs a limp home mode in which the vehicle is driven by utilizing both the P1 motor 121 and the engine 110.

The P2 motor 122 is connected to one of the front or rear wheels, and the P1 motor 121 is connected to the other of the front or rear wheels. Hereinafter, for convenience of explanation, the P2 motor 122 and the P1 motor 121 may be briefly referred to as P2 and P1, respectively.

The high voltage battery 140 supplies a power to or charges the P2 motor 122 and/or the P1 motor 121.

Additionally, the high-voltage battery 140 may be charged with an external power source via a plug.

The P2 motor 122 transmits a power to the second axle 152 through the second reducer 132.

The P1 motor 121 is connected to the first axle 151 through the first reducer 131, and the power is transmitted or blocked depending on the engagement or disengagement of the first clutch C1.

In addition, the engine 110 and the P1 motor 121 may be connected via the first clutch C1 along the first axle 151, and the power may be transmitted or blocked depending on the engagement or disengagement of the first clutch C1.

The PT system 100 may operate in an EREV mode in which a high-voltage battery 140 is charged by operating the P1 motor 121 as a generator using the power from the engine 110, while the vehicle is driven by the P2 motor 122. In the EREV mode, the first clutch C1 is engaged and the second clutch C2 is disengaged (referring to FIG. 1).

In particular, the PT system 100 may operate in the limp home mode by utilizing both the P1 motor 121 and the engine 110 when a failure event occurs in the P2 motor 122 and it becomes inoperable.

This PT system 100 is similar to the structure of a conventional EREV (an extended-range electric vehicle) in that it is driven by the electric motors P1 and P2 and is equipped with a high-voltage battery that is charged using an engine. However, it is different in that it may be controlled in a HEV mode by utilizing both the P1 motor 121 and the engine 110 in the limp home mode as shown in FIG. 2.

The controller 200 may be a high-level hybrid control unit (HCU) that integrates and controls control means of each component of the PT system 100 (ex: Electronic Control Unit, Motor Control Unit, Clutch Control Unit, and Battery Management System, etc.).

The controller 200 includes a status information monitoring unit 210 that detects status information required for the limp home mode control from various sensors and/or controllers while the vehicle is driving.

For example, the status information monitoring unit 210 may monitor a status information in real time, including a P2 motor failure event, a vehicle speed, an engine rpm, a state of charge (SOC) of a battery, engagement/disengagement states of clutches C1 and C2, an operation amount of an acceleration/deceleration pedal, etc., and transmit the information to the controller 200.

The controller 200 controls the vehicle in the EREV mode, in which the vehicle is driven by the P2 motor 122 during a normal driving and the P1 motor 121 operates as a generator with the power from the engine 110 to charge the high-voltage battery 140. At this time, the controller 200 controls the first clutch C1, which connects the engine 110 and the P1 motor 121, to be engaged, and controls the second clutch C2, which connects the P1 motor 121 and the first axle 151, to be disengaged.

On the other hand, the controller 200 is configured to enter the limp-home mode when a failure occurs in the P2 motor 122, to engage (directly connect) both the first clutch C1 and the second clutch C2, and to operate in the HEV mode that utilizes both the power from the P1 motor 121 and the engine 110.

The disclosed content aims to maintain a safe driving state (a fail-safe mode) by utilizing an engine output even when the SOC remaining amount of the high-voltage battery 140 is insufficient in the limp-home mode of the hybrid vehicle through such a controller 200.

The controller 200 may be implemented as one or more processors operating according to a predetermined program, and the predetermined program may be configured to perform each step of the limp-home mode control method in the event of the motor failure in the hybrid vehicle according to one embodiment. The controller 200 include a computer-readable recording medium on which a program for implementing the limp-home mode control method in the event of the motor failure in the hybrid vehicle is recorded.

The limp-home mode control method in the event of the motor failure in such hybrid vehicles is described in more detail with reference to the drawings below.

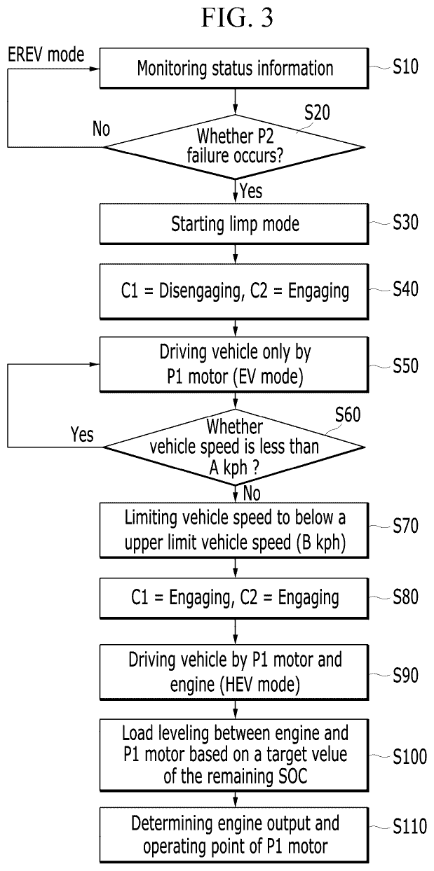

FIG. 3 is a flowchart schematically illustrating a limp-home mode control method in the event of a motor failure in a hybrid vehicle according to one embodiment.

Referring to FIG. 3, according to an embodiment, a controller 200 of a hybrid vehicle controls the vehicle in a general EREV mode after startup of the vehicle and monitors driving status information in real time (in an operation S10).

In an operation S20, the controller 200 checks whether the failure has occurred in the P2 motor 122, which drives the second axle 152, during the monitoring. When no failure event occurs (“No” in the S20), it continues operating in the EREV mode.

On the other hand, if the controller 200 detects the occurrence of the failure in the P2 motor 122 during the monitoring (i.e., “Yes” in the S20), it initiates the limp home mode to stabilize the driving of the vehicle (in an operation S30). At this time, the controller 200 may display the limp home mode entry situation due to the failure of the P2 motor 122 through a vehicle terminal (ex: an AVN, a cluster) to alert the driver.

The controller 200 releases the first clutch C1 connected between the engine 110 and the P1 motor 121 in the limp home mode and engages the second clutch C2, which connects the P1 motor 121 and the first reducer 131 to the first axle 151 (in an operation S40).

Also, the controller 200 controls the vehicle in an EV mode in which the vehicle is driven using only the P1 motor 121 (in an operation S50). In other words, in the EV mode, only the driving force of the P1 motor 121 is transmitted to the first axle 151 through the first reducer 131 and the second clutch C2.

Meanwhile, the controller 200 determines whether the current vehicle speed, detected as part of the status information, exceeds a lower limit vehicle speed (A km/h “kph”) that is predetermined as an engine start maintenance condition (in an operation S60). Here, the engine start maintenance condition refers to the lowest vehicle speed corresponding to the degree that the engine does not turn off when the vehicle starts or creeps.

At this time, if the current vehicle speed is lower than or equal to the lower limit vehicle speed (A kph) (i.e., “Yes” in the S60), the controller 200 drives the vehicle using only the P1 motor 121 (in the S50).

On the other hand, if the current vehicle speed exceeds the lower limit vehicle speed (A kph) (“No” in the S60), the controller 200 drives the vehicle by using the engine 110 and the P1 motor 121 simultaneously.

More specifically, the controller 200 limits the vehicle speed to below an upper limit vehicle speed (B kph) predetermined in the limp home mode (in an operation S70).

The controller 200 engages both the first clutch C1 and the second clutch C2 (in an operation S80) and controls the vehicle in an HEV mode that uses both the driving power of the P1 motor 121 and the engine 110 to drive the vehicle (in an operation S90). Accordingly, in the HEV mode, the driving power of the P1 motor 121 and the engine 110 combined is transmitted to the first axle 151 through the first reducer 131 and the second clutch C2.

Here, the upper limit speed (B kph) be set as the speed at a maximum engine rpm determined by a reduction ratio of the first reducer 131.

For example, when the gear ratio of the first reducer 131 is designed to be 10:1, the lower limit (minimum) rotation speed at which the engine does not start is 1200 rpm, the upper limit (maximum) rotation speed of the engine is 6000 rpm, and the vehicle's diameter is 0.321 m, the method for determining A kph and B kph is as shown in Equation 1 below.

$$\begin{matrix}A kph = 1200 rpm \times 10 \times 0.321 \times \frac{π}{60} \times 3.6 = 18.2 kph \\ B kph = 6000 rpm \times 10 \times 0.321 \times \frac{π}{60} \times 3.6 = 72.6 kph\end{matrix} \qquad ( Equation 1 )$$

In addition, the controller 200 engages both the first clutch C1 and the second clutch C2 to use the P1 motor 121 and the engine 110 in the limp home mode, and then performs a load leveling based on the SOC remaining amount of the high voltage battery 140 (in an operation S100), and determines the engine output (a torque) and the operating point of the P1 motor 121 (in an operation S110).

Here, the load leveling control is not a load balancing between the engine and the motor based on the engine efficiency point, as in the normal HEV driving, but rather refers to a load leveling control based on the remaining SOC of the high-voltage battery 140. In other words, the controller 200 may set a target value (X SOC) of the SOC for the limp home mode and perform the load leveling control so that the current SOC follows the target value (X SOC). This is to secure a certain amount of the SOC of the battery for the use of the P1 motor 121, since the P1 motor 121 must be used when the vehicle is driven below the lower limit rotation speed (A rpm).

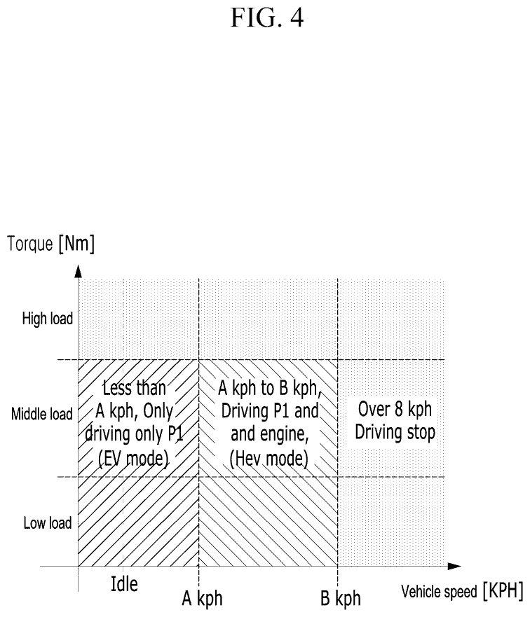

FIG. 4 is a view illustrating a driving control method of an engine and a P1 motor by comparing a speed and torque map (MAP) according to one embodiment.

Referring to FIG. 4, a controller 200 according to one embodiment compares a vehicle speed and a torque map (MAP) and controls the vehicle in an EV mode in which the vehicle is driven only by the P1 motor 121 when a speed is lower than a lower limit vehicle speed (A kph).

In addition, the controller 200 controls the vehicle in the HEV mode in which the vehicle is driven using the engine 110 and the P1 motor 121 so that the SOC of the high-voltage battery 140 follows the target value (X SOC) when the vehicle speed is between the lower limit vehicle speed (A kph) and the upper limit vehicle speed (B kph).

At this time, as mentioned above, according to one embodiment, the load leveling is performed based on the remaining SOC of the high-voltage battery 140 to secure the target value (X SOC), which is completely different from the load leveling based on the conventional engine efficiency curve.

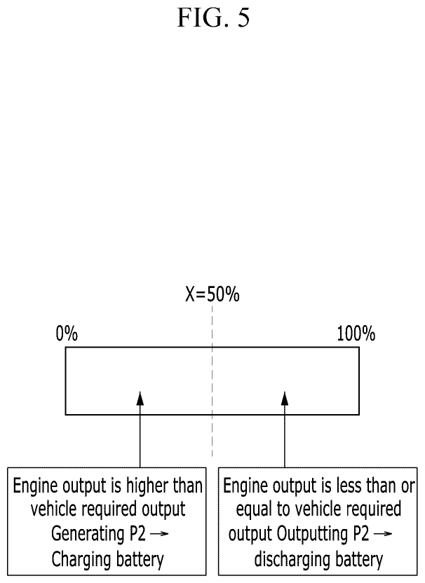

For example, FIG. 5 is a view showing an example of a battery SOC target tracking load leveling control according to one embodiment.

Referring to FIG. 5, it is assumed that the target value (X SOC) of the battery SOC is 50%. When the SOC of the high-voltage battery 140 is lower than the target value 50%, the controller 200 may control the engine output to be higher than the vehicle required output and operate the P1 motor 121 as a generator to charge the high-voltage battery 140.

On the other hand, when the remaining SOC of the high-voltage battery 140 is higher than the target value 50%, the controller 200 may control the output of the engine 110 to be lower than the required output of the vehicle and supply (discharge) the power of the high-voltage battery 140 to the P1 motor 121 so that the P1 motor 121 assists the engine output.

Additionally, the controller 200 may limit the vehicle speed so that the vehicle does not exceed the upper limit speed (B kph).

In this way, according to one embodiment, in the EREV system that uses the engine for the charging, the reliability of the vehicle product may be improved by providing the safe driving (fail-safe) by utilizing the engine output for the limp home mode in the event of the motor failure.

In addition, since the conventional EREV system may be used as it is and the limp-home mode performance may be improved by only changing the software without any additional hardware (e.g., a transmission, clutch, etc.), it has the effect of improving the marketability without an additional cost.

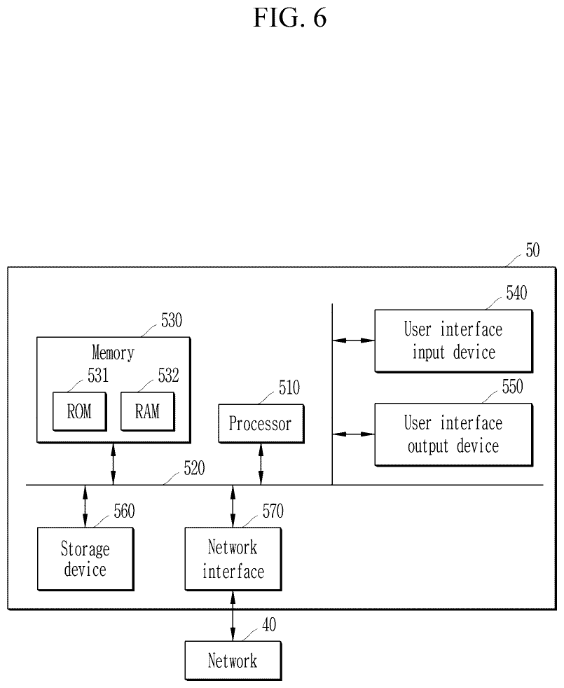

FIG. 6 is a diagram illustrating a computing device according to one embodiment.

Referring to FIG. 6, a method for controlling a hybrid vehicle according to embodiments can be implemented using a computing device (50). These computing devices 50 can be implemented as various types of electronic devices, servers or similar devices, and their functions can be implemented through a combination of software and hardware.

The computing device 50 may include at least one of a processor 510, a memory 530, a user interface input device 540, a user interface output device 550, and a storage device 560 communicating via a bus 520. The computing device 50 may also include a network interface 570 electrically connected to a network 40. The network interface 570 may transmit or receive signals to or from other virtual objects via the network 40.

The processor 510 may be implemented as various types of computational units, such as a micro controller unit (MCU), an application processor (AP), a central processing unit (CPU), a graphic processing unit (GPU), an neural processing unit (NPU), a quantum processing unit (QPU), etc. The processor 510 is a semiconductor device that executes instructions stored in memory 530 or a storage device 560 and can play a key role in the system. Program codes and data stored in the memory 530 or the storage device 560 instruct the processor 510 to perform specific tasks, thereby enabling the overall operation of the system. The processor 510 may be configured to implement various functions and methods described above with respect to FIG. 1 to FIG. 5.

The memory 530 and the storage device 560 may include various forms of volatile or non-volatile storage media for storing and accessing data of the system. For example, the memory 530 may include a read-only memory (ROM) 531 and a random access memory (RAM) 532. In some embodiments, the memory 530 may be built into the processor 510, in which case data transfer speeds between the memory 530 and the processor 510 may be very fast. In some other embodiments, the memory 530 may be located external to the processor 510, in which case the memory 530 may be connected to the processor 510 via various data buses or interfaces. This connection may be made via a variety of known means, for example the Peripheral Component Interconnect Express (PCIe) interface for high-speed data transfer or via a memory controller.

In some embodiments, at least some of the components or functions of the control method and device of the hybrid vehicle according to the embodiments may be implemented as a program or software running on the computing device 50, and the program or software may be stored on a computer-readable recording medium or storage medium. Specifically, a computer-readable recording medium or storage medium according to an embodiment may be a computer having recorded thereon a program for causing a computer including the processor 510 that executes a program or command stored in the memory 530 or the storage device 560 to execute steps included in the implementation of a control method and device for a hybrid vehicle according to the embodiments.

In some embodiments, at least some of the components or functions of the control method and device of the hybrid vehicle according to the embodiments may be implemented using hardware or circuitry of the computing device 50, or may be implemented as separate hardware or circuitry that may be electrically connected to the computing device 50.

In some embodiments, the computing device 50 may be provided with one or more non-transitory computer-readable media including executable instructions, which, when executed by one or more processors of the computing device 50, cause the computing device 50 to perform operations. Here, the operation may include the configuration, function, step, etc. described in this specification with respect to the control method and device of the hybrid vehicle according to the embodiments.

One embodiment may not be implemented only through the devices and/or methods described above, but may also be implemented through a program for realizing a function corresponding to the configuration of one embodiment, a recording medium on which the program is recorded, etc.

While this present disclosure has been described in connection with what is presently considered to be practical embodiments, it is to be understood that the present disclosure is not limited to the disclosed embodiments, but, on the contrary, is intended to cover various modifications and equivalent arrangements included within the spirit and scope of the appended claims.

### DESCRIPTION OF SYMBOLS

1: hybrid vehicle
110: engine
121, 122: P1, P2 motor
C1, C2: first, second clutch
131, 132: first, second reducer
140: high voltage battery
151, 152: first, second axel
200: controller
210: status information monitoring unit

What is claimed is:

1. A method of controlling a hybrid vehicle including a first motor configured to provide a driving force to one of front or rear wheels, and a second motor configured to provide a driving force to the other of the front or rear wheels, the method comprising:
initiating, by a controller, a limp home mode based on determining that a failure in the second motor is detected while the hybrid vehicle is operating;
determining, by the controller, whether a vehicle speed of the hybrid vehicle in the limp home mode is less than or equal to a predetermined lower limit vehicle speed predetermined based on a condition for maintaining an engine start;
controlling, by the controller, the hybrid vehicle in an electric vehicle (EV) mode in which the hybrid vehicle is driven using only the first motor based on determining that the vehicle speed is less than or equal to the predetermined lower limit vehicle speed; and
controlling, by the controller, the hybrid vehicle in a hybrid electric vehicle (HEV) mode in which the hybrid vehicle is driven using both the engine and the first motor based on determining that the vehicle speed exceeds the predetermined lower limit vehicle speed.

2. The method for controlling the hybrid vehicle of claim 1, wherein controlling the hybrid vehicle in the EV mode includes:
disengaging a first clutch provided between the engine and the first motor, and engaging a second clutch provided between a first reducer and a first axle to control the vehicle speed and a torque of the first motor.

3. The method for controlling the hybrid vehicle of claim 1, wherein:
controlling the hybrid vehicle in the HEV mode includes:
limiting the vehicle speed to a predetermined upper limit vehicle speed predetermined in the limp home mode; and
engaging a first clutch provided between the engine and the first motor, and a second clutch provided between a first reducer and a first axle for controlling the vehicle speed and a torque of the first motor.

4. The method for controlling the hybrid vehicle of claim 3, wherein:
the predetermined upper speed limit is set as a vehicle speed at a maximum engine rpm determined by a reduction ratio of the first reducer.

5. The method for controlling the hybrid vehicle of claim 1, wherein controlling the hybrid vehicle in the HEV mode includes:
performing a load leveling based on a state of charge (SOC) of a high-voltage battery that is configured to supply power to the second motor and the first motor or to be charged with power generated by the second motor and the first motor; and
determining an engine output and an operating point of the first motor.

6. The method for controlling the hybrid vehicle of claim 5, wherein performing the load leveling includes:
setting a target SOC value based on a current SOC of the high-voltage battery for the limp home mode; and
controlling the engine and the first motor so that the current SOC follows the target SOC value.

7. The method for controlling the hybrid vehicle of claim 5, wherein determining the engine output and the operating point of the first motor includes:
controlling the engine output to be higher than a required output of the hybrid vehicle based on determining that a current SOC of the high-voltage battery is less than a target SOC value, and generating power through the first motor to charge the high-voltage battery.

8. The method for controlling the hybrid vehicle of claim 5, wherein determining the engine output and the operating point of the first motor includes:
controlling the engine output to be lower than a vehicle required output based on determining that a current SOC of the high-voltage battery is greater than a target SOC value, and supplying power of the high-voltage battery to the first motor to assist the engine output.

9. A non-transitory computer-readable medium storing instructions that, when executed by a computing device including one or more processors, cause the computing device to perform a method of controlling a hybrid vehicle including a first motor powering one of front or rear wheels, and a second motor powering the other of the front or rear wheels, the method comprising:
initiating a limp home mode based on determining that a failure in the second motor is detected while the hybrid vehicle is operating,
determining whether a vehicle speed of the hybrid vehicle detected in the limp home mode exceeds a predetermined limit speed based on an engine start maintenance condition,
controlling the hybrid vehicle in an electric vehicle (EV) mode, in which the hybrid vehicle is driven using only the first motor based on determining that the vehicle speed does not exceed the predetermined limit speed,
controlling the hybrid vehicle in a hybrid electric vehicle (HEV) mode in which the hybrid vehicle is driven using the engine and the first motor based on determining that the vehicle speed exceeds the predetermined limit speed.

10. A hybrid vehicle comprising:
a first motor configured to provide a driving force to one of front or rear wheels;
a second motor configured to provide a driving force to the other of the front or rear wheels; and
a controller configured to:
initiate a limp-home mode upon determining that a failure in the second motor is detected while the hybrid vehicle is operating,
determine whether a vehicle speed of the hybrid vehicle in the limp-home mode is less than or equal to a predetermined low-limit vehicle speed based on a condition for maintaining engine start,
control the hybrid vehicle in an electric vehicle (EV) mode in which the hybrid vehicle is driven using only the first motor, when it is determined that the vehicle speed is less than or equal to the predetermined low-limit vehicle speed, and
control the hybrid vehicle in a hybrid electric vehicle (HEV) mode in which the hybrid vehicle is driven using both the engine and the first motor, when it is determined that the vehicle speed exceeds the predetermined low-limit vehicle speed.

11. The hybrid vehicle of claim 10, wherein the controller is further configured to:
limit the vehicle speed to a predetermined upper limit vehicle speed predetermined in the limp home mode; and
control engagement of a first clutch provided between the engine and the first motor, and a second clutch provided between a first reducer and a first axle for to control the vehicle speed and a torque of the first motor.

12. The hybrid vehicle of claim 11, wherein the predetermined upper limit vehicle speed is set based on a vehicle speed corresponding to a maximum engine rpm determined by a reduction ratio of a first reducer.

13. The hybrid vehicle of claim 10, wherein, to control the hybrid vehicle in the HEV mode, the controller is further configured to:
perform load leveling based on a state of charge (SOC) of a high-voltage battery configured to supply power to the second motor and the first motor, or to be charged with power generated by the second motor and the first motor; and
determine an engine output and an operating point of the first motor.

14. The hybrid vehicle of claim 13, wherein, to perform the load leveling, the controller is configured to:
set a target SOC value based on a current SOC of the high-voltage battery for the limp home mode; and
control the engine and the first motor such that the current SOC follows the target SOC value.
